(19) United States
(12) Patent Application Publication
(10) Pub. No.: US 2013/0179931 A1
(43) Pub. Date: Jul. 11, 2013

(54) PROCESSING, STORING, AND DELIVERING DIGITAL CONTENT

(71) Applicants: Daniel Osorio, Park City, UT (US); Robert L. Bishop, North Salt Lake, UT (US)

(72) Inventors: Daniel Osorio, Park City, UT (US); Robert L. Bishop, North Salt Lake, UT (US)

(21) Appl. No.: 13/385,590

(22) Filed: Nov. 2, 2010

(51) Int. Cl. G06F 15/167; H04N 21/637

(52) U.S. Cl. CPC G06F 15/167; H04N 21/637
USPC 725/110; 709/213

(57) ABSTRACT

Implementations of the present invention include a Public Cloud, one or more End-Caches and optionally one or more Edge-Caches in computerized architecture that provides digital content, such as entertainment services and/or informational content, to a guest display (i.e., End-Cache connected to in-room TV). Implementations of the present invention also include a Content Distribution Architecture that uses the public Internet to securely broadcast large digital media file(s) simultaneously to all desired locations (e.g., Edge-Caches). Implementations of the present invention further include a Channel Processor that uses a video-input agnostic approach (i.e., composite, sVideo, component, HDMI) to take whatever video signal (i.e., std-def, high-def) and make it better (i.e., all digital, all high-def quality). Implementations of the present invention therefore improve distribution of entertainment to end users, as well as the playback thereof.

### CROSS-REFERENCE TO RELATED APPLICATIONS

N/A

### BACKGROUND

### Background and Relevant Art

The switch to high-definition or “high-def” content has presented a number of challenges for commercial markets, including: the need for new TV channel line-up equipment (high-def capable), new VOD movie equipment (high-def capable) if desired, the need to encrypt high-def content for security purposes, the need for new TVs (high-def capable), the additional cost of special decryption high-def TVs, the lack of high-def TV channels, the poor quality of std-def analog channels viewed on high-def TVs, the delays in switching TV channels (e.g., between analog and digital TV tuners), the switch from MPEG-2 to MPEG-4 encoding by content providers (rendering most existing high-def TVs incompatible), and the high-cost of current, yet incomplete solutions.

For years, video-on-demand or “VOD” movies have been considered a necessary amenity for in-room entertainment. The high-def upgrade path for these systems, however, is virtually non-existent (e.g., system components are not upwards-compatible and the entire system is commonly discarded). Rather than purchase new high-def VOD movie systems, many choose to forego VOD movies altogether and install only high-def TV but with premium channels (e.g., HBO, Showtime, Starz, Encore, and the like). The up-front investment is less costly for these systems but monthly content fees are more expensive (e.g., additional fees assessed for premium channels are per-room, per-month; whether occupied or not). This stands in stark contrast to standard channel fees offset by incremental room revenue of the TV with VOD movies model.

Also, many believe that movies are so easily downloaded or streamed from the Internet (e.g., iTunes, NetFlix) that the need for VOD movie systems is no longer needed; especially given the high-cost for both the equipment (e.g., often double or triple that of a TV system alone) and its content (e.g., which can be double or triple the cost of theater admission and many times more expensive than DVD rental). Notwithstanding, the bandwidth requirements for streaming movies from the Internet is often not practical, portable computer screen sizes can suffer as entertainment displays, and personal content has usually been viewed many times (lessoning the desire to view it again).

### BRIEF SUMMARY

The present invention includes one or more systems, computer program(s), and process(es) configured to provide a high-featured yet inexpensive in-room entertainment and information system (which can include VOD movies) that is more affordable for owners and their guests; overcoming major obstacles in the switch to high-def content.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1.1 is a schematic view that illustrates the manner in which an application interacts with an API to allocate, manage, and release data resources of a given Cloud Provider in the Public Cloud;

FIG. 1.2 is a schematic view that illustrates the manner in which Cloud Provider APIs can be abstracted into a general purpose “Public-Intercloud API,” allowing applications to operate independent of a given Cloud Provider and its corresponding API;

FIG. 2.1 is a schematic view that illustrates the manner in which the Resource Monitor can interact with instance(s) of Application Module(s) in the Public Cloud;

FIG. 2.2 is a schematic view that illustrates the manner in which the Resource Monitor can interact with instance(s) of Application Module(s) in the Public Cloud;

FIG. 3 is a schematic view that illustrates the manner in which Application Modules that make up the computer program(s) functionality can be decentralized across the Public Cloud;

FIG. 4 is a schematic view that illustrates the manner in which the Private Cloud can be connected to the Public Cloud;

FIG. 5 is a schematic view that illustrates Application Module(s) in a Public Cloud cached through a private network to Edge-Caches in the Private Cloud as well as Edge-Cache failure recovery;

FIG. 6.1 is a schematic view that illustrates the manner in which the End-Cache interacts with Application Module(s) (whether at the Edge-Cache or the Public Cloud) as well as input and output devices;

FIG. 6.2 is a schematic view that illustrates the manner in which the End-Cache monitors the TV stream as well as failure recovery;

FIG. 7.1 is a schematic view that illustrates the manner in which a device is connected to the back of a Hospitality TV for program control;

FIG. 7.2 is a schematic view that illustrates the manner in which Hospitality TV APIs can be abstracted into a general purpose “TV API,” allowing applications to operate independent of a given Hospitality TV and its corresponding API;

FIG. 8.1 is a schematic view that illustrates how attempts to broadcast file(s) using the public Internet are ignored (e.g., blocked or fire-walled) and the data is automatically discarded;

FIG. 8.2 is a schematic view that illustrates how one-to-one file transfers are properly routed over the public Internet;

FIG. 8.3 is a schematic view that illustrates the manner in which Edge-Caches in the Private Cloud can be securely connected to the Public Cloud utilizing a “Mesh” VPN;

FIG. 8.4 is a schematic view that illustrates how multicast traffic can be encrypted and encapsulated so that it passes undisturbed through standard network transport layers of the public Internet;

FIG. 8.5 is a schematic view that illustrates the manner in which multicast traffic is broadcast;

FIG. 9.1 is a schematic view that illustrates a content distribution file;

FIG. 9.2 is a schematic view that illustrates content distribution from Application Module(s) in the Public Cloud to corresponding EdgeCache(s);

FIG. 10 is a schematic view that illustrates the CP including its inputs and output;

FIG. 11.1 is a schematic view that illustrates the manner in which a TV signal travels from its source to the End-Cache;

FIG. 11.2 is a schematic view that illustrates the manner in which channels are mapped;

FIG. 12.1 is a schematic view that illustrates the main user interface elements displayed by the End-Cache;

FIG. 12.2 is a schematic view that illustrates a DVD player remote control;

FIG. 12.3 is a schematic view that illustrates vertical navigation; and

FIG. 12.4 is a schematic view that illustrates horizontal navigation.

### DETAILED DESCRIPTION

Implementations of the present invention include an architecture comprising a Public Cloud, one or more End Caches, and optionally one or more Edge-Caches. In this architecture, an application and its functionality (i.e., Application module(s) and their corresponding data) live in the cloud (i.e., Public Cloud); are cached where they are currently physically needed (i.e., Edge-Cache); and provide digital content, such as entertainment and/or informational content, to a guest display (i.e., End-Cache connected to in-room TV). Accordingly, this allows the application/data to be decentralized across the Public Cloud, thereby increasing reliability, lowering risk, lower costs, and removing barriers for growth/retrenchment. In addition, the system architecture anticipates eventual resolution of the current speed/bandwidth versus cost barrier to the public Internet (for high-bandwidth content), thereby possibly removing the need for a local cache.

Implementations of the present invention also include a Content Distribution Architecture. In this architecture, an application and its functionality (i.e., Application Module(s) and their corresponding data) in the cloud (i.e., Public Cloud) use the public Internet to securely broadcast large digital media file(s) simultaneously to all desired locations (e.g., Edge-Caches). Accordingly, this allows Distribution files to be broadcast in a very affordable (i.e., required bandwidth is no larger than that needed for a connection to a single location) and scalable (i.e., there is no change in bandwidth requirements as the number of locations increase) way. In addition, complex content distribution is more easily managed through distribution file attributes that can include: property type, language, culture, geographic location, and defined group.

Implementations of the present invention further include a Channel Processor (“CP”). In general, the CP uses a video-input agnostic approach (i.e., composite, sVideo, component, HDMI) to take whatever video signal (i.e., std-def, high-def) and make it better (i.e., all digital, all high-def quality). Accordingly, the CP overcomes the typically poor quality of std-def analog signals viewed on high-def TVs (i.e., outputs only digital high-def), makes moot previous delays in switching TV channels (e.g., between analog and digital TV tuners); and improves even high-def signals (through video processing).

The “Public Cloud” consists of computing and data resources connected to the public Internet offered on-demand by one or more independent service providers (e.g., Amazon, Gogrid, Rackspace). Each Public Cloud service provider or “Cloud Provider” supplies an application program interface or “API” to allocate, manage, and release the computing and data resources it offers.

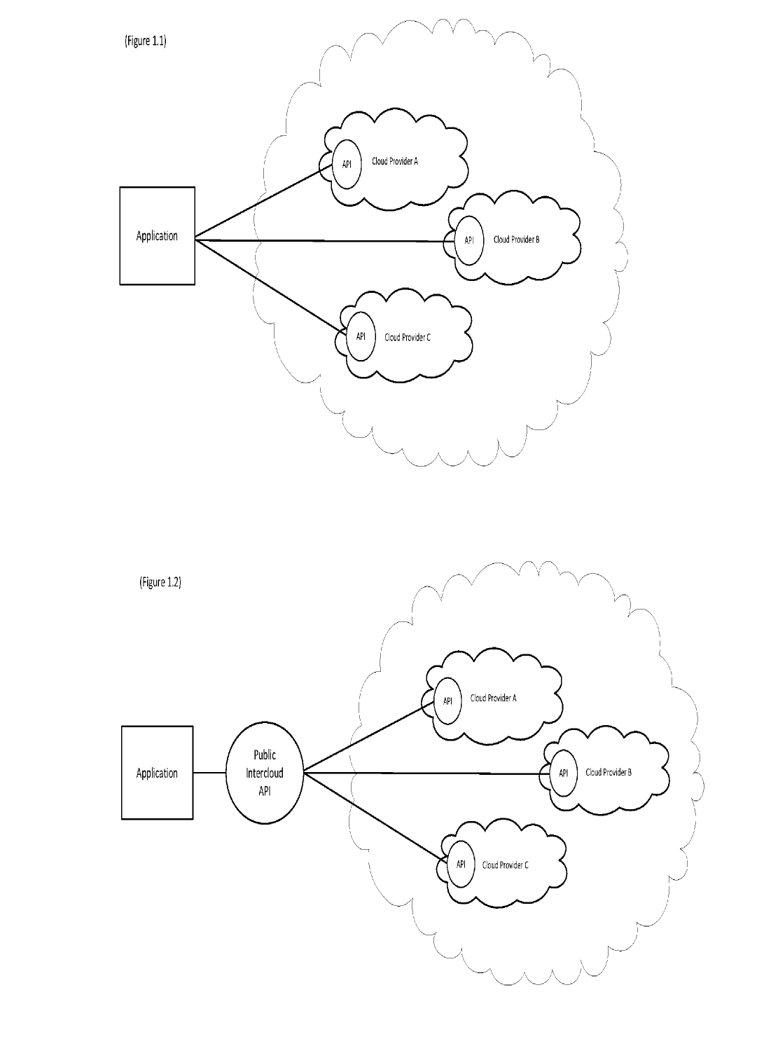

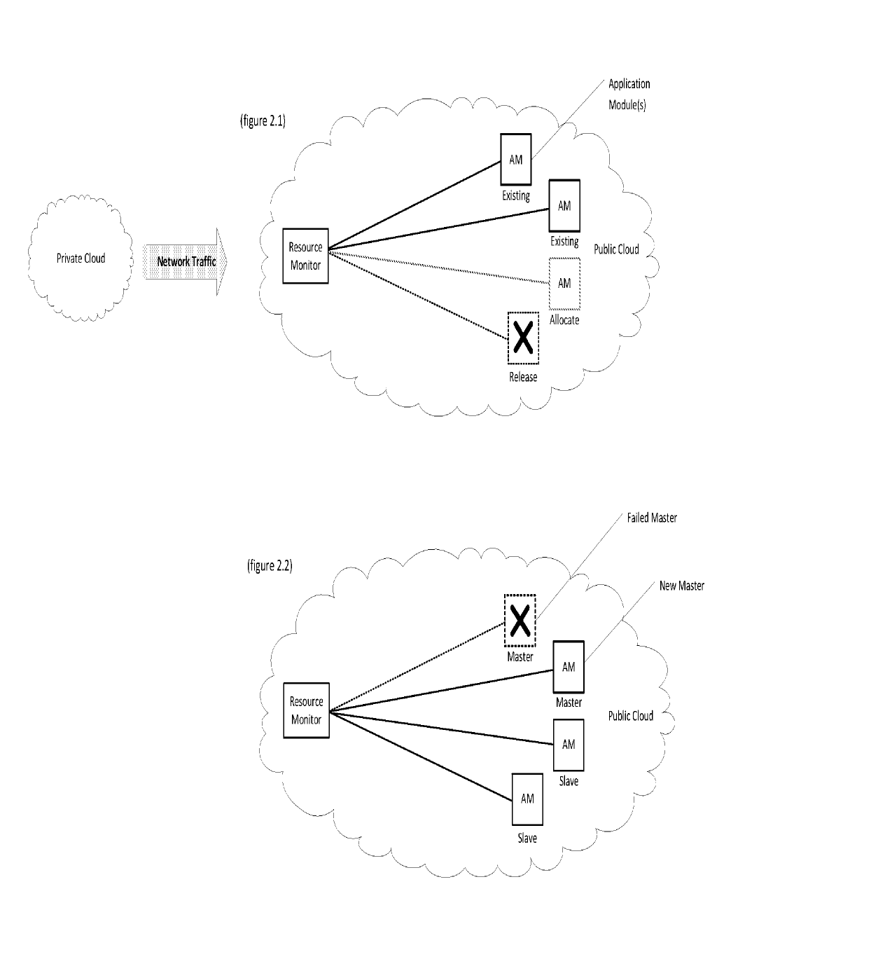

FIG. 1.1 is a schematic view that illustrates the manner in which an application interacts with an API to allocate, manage, and release data resources of a given Cloud Provider in the Public Cloud. In the illustrated embodiment, a plurality of Cloud Providers with their corresponding APIs are depicted, including Cloud Provider A with its API, Cloud Provider B with its API, and Cloud Provider C with its API. According to the illustrated embodiment, although each Cloud Provider API is specific to a given Cloud Provider, Cloud Provider APIs themselves offer similar functionality and operate in a similar fashion.

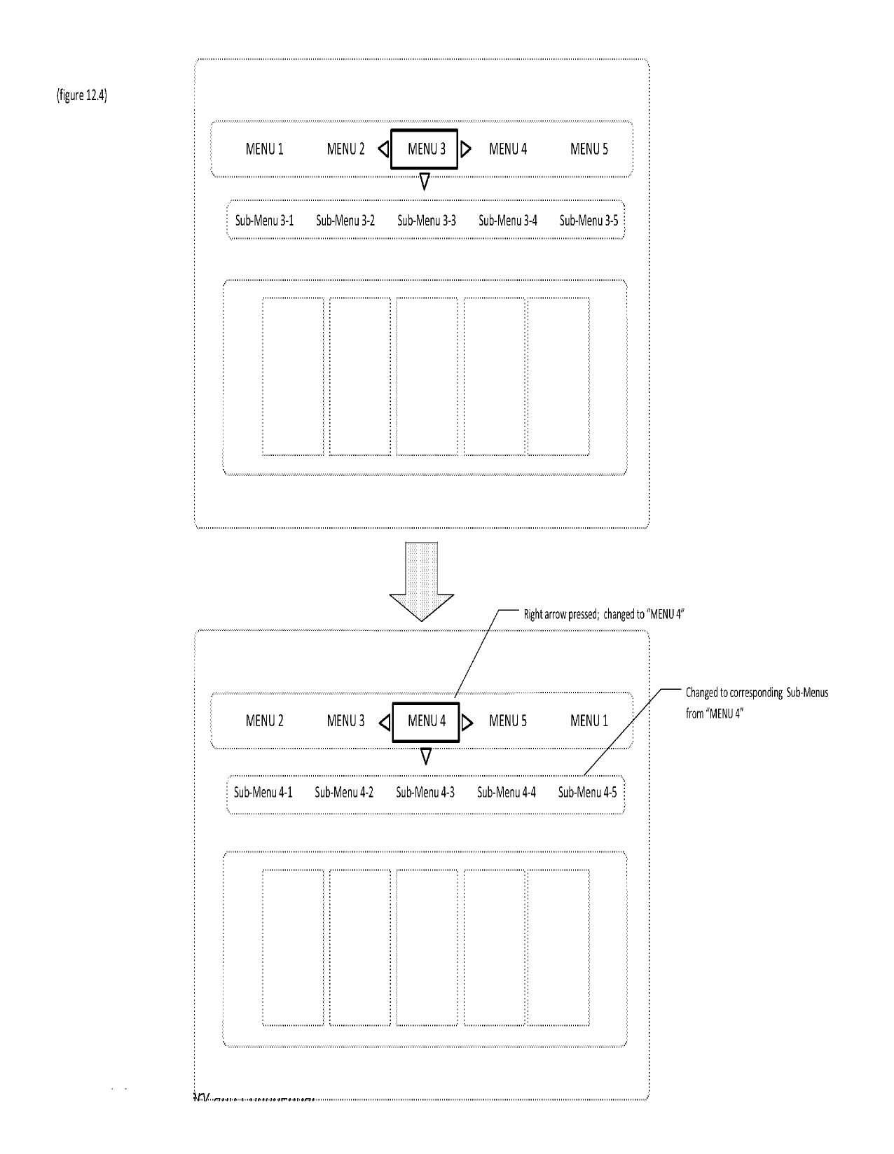

FIG. 12 is a schematic view that illustrates the manner in which Cloud Provider APIs can be abstracted into a general purpose “Public-Intercloud API,” allowing applications to operate independent of a given Cloud Provider and its corresponding API. In the illustrated embodiment, an application interacts with a single Public-Intercloud API to allocate, manage, and release data resources of several Cloud Providers in the Public Cloud, including Cloud Provider A, Cloud Provider B, and Cloud Provider C. This can be done by mapping the functional equivalent of each Public-Intercloud API call to its specific implementation using the given Cloud Provider API. In this way, supporting an additional Cloud Provider becomes the simple task of mapping the Public-Intercloud API to the new Cloud Provider API rather than the task of re-writing or reworking a large base of application program source code.

### Resource Monitor

In the illustrated embodiment, the “Resource Monitor” is an application that can utilize the Public Intercloud API to allocate, manage, and release instances of application functionality or “Application Modules” in the Public Cloud. The Resource Monitor can allocate and release instances of these Application Modules in accordance with established “Rules,” each of which has a minimum and maximum threshold. When the maximum threshold is reached by one or more instances of a particular Application Module, a new instance of that Application Module is allocated and demand is re-distributed to incorporate the new instance of the Application Module. According to one aspect of the present invention, when the minimum threshold is reached by two or more instances of a particular Application Module, one instance is released and demand is re-distributed to the remaining instance(s).

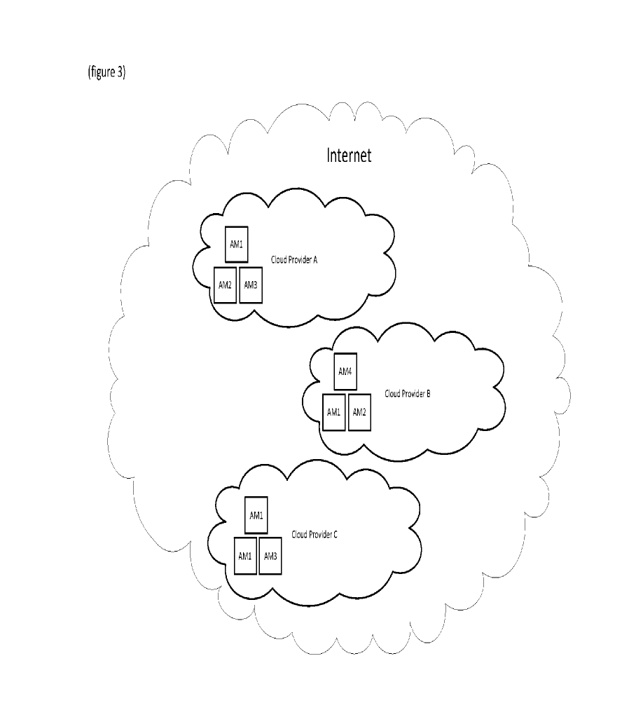

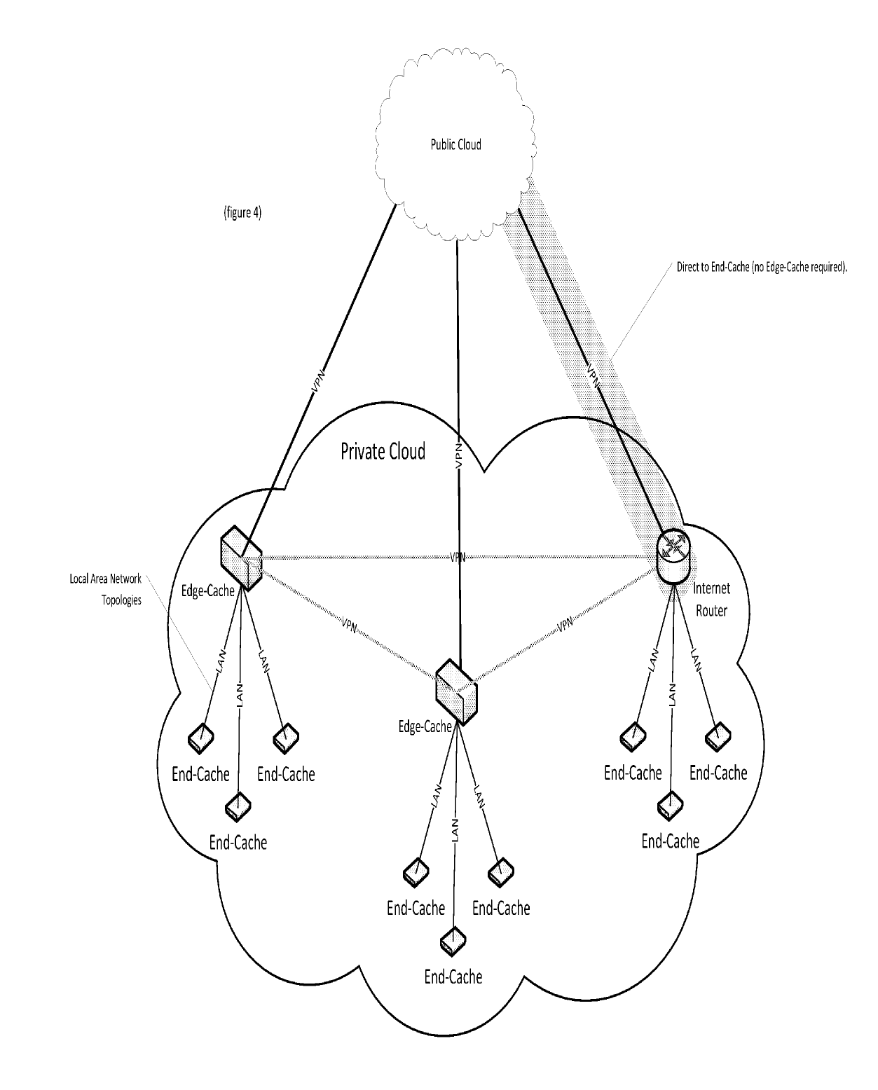

FIG. 2.1 is a schematic view that illustrates the manner in which the Resource Monitor can interact with instance(s) of Application Module(s) in the Public Cloud. In the illustrated embodiment, instances of an Application Module in the Public Cloud are depicted, including two existing instances, a newly allocated instance (i.e., showing what takes place when the maximum threshold is reached), and a newly released instance (i.e., showing what takes place when the minimum threshold is reached).

The Resource Monitor can also designate the first instance of a particular Application Module as the “master” instance. Each instance thereafter can be designated as a “slave” instance. According to one embodiment of the present invention, there is no difference in the Application Module itself, only its designation—master or slave. This ensures that one instance remains running (i.e., the master instance is not released whereas slave instance(s) are allocated/released based on demand). However, if the master instance of a given Application Module becomes unavailable (e.g., connection failure, hardware failure), the Resource Monitor can immediately designate the first slave instance as “master” (or allocates a new instance of the Application Module if no slave exists) and redistributes the load.

FIG. 2.2 is a schematic view that illustrates the manner in which the Resource Monitor can interact with instance(s) of Application Module(s) in the Public Cloud. In the illustrated embodiment, instances of a single Application Module in the Public Cloud are depicted, including an original master instance that fails, a previous slave instance which is designated as the new master instance, and two additional slave instances. If or when the original master instance is available again, the Resource Monitor may keep the original master instance and remove the “master” designation from the first slave instance (possibly releasing it altogether) or release the original master instance depending on network load and risk.

The Resource Monitor can also monitor (e.g., gather statistical data) and load balance (e.g., distribute system demand) among instances of each Application Module in the Public Cloud. Instances are allocated and released on demand to maximize system performance and minimize system cost.

### Application Modules

In the illustrated embodiment, the computer program(s) or computer code or any other functionality of the present invention comprise one or more Application Modules that supply the overall functionality of the system (e.g., management, reporting, billing, monitoring, asset management, customer management, guest management, content management and serving, channel management and serving, concierge management and serving, EPG management and serving, advertising management and serving, and GUI management are examples of potential Application Modules). Each instance (i.e., computing and data resources expressed in virtualized hardware resources in the Public Cloud) of an Application Module contains the program logic and associated data for that particular module.

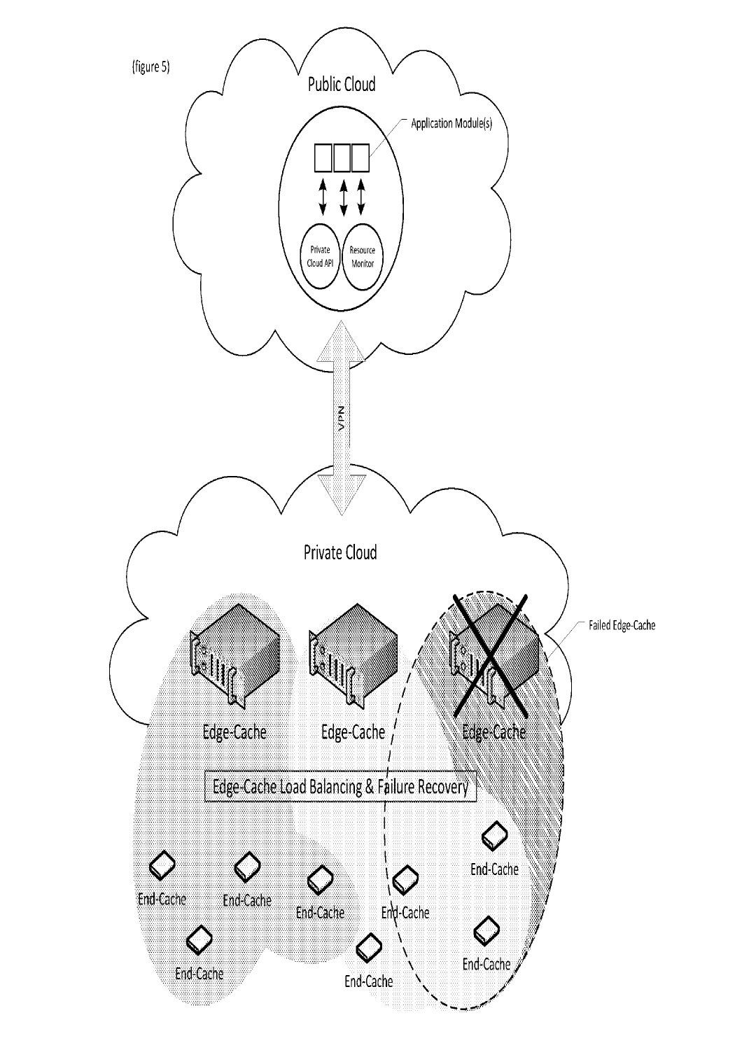

FIG. 3 is a schematic view that illustrates the manner in which Application Modules that make up the computer program(s) functionality can be decentralized across the Public Cloud. In the illustrated embodiment, instances of Application Modules in the Public Cloud are depicted, including instances of Application Modules 1, 2, and 3 in Cloud Provider A, instances of Application Modules 1, 2, and 4 in Cloud Provider B, and instances of Application Modules 1 and 3 in Cloud Provider C. The illustration also demonstrates that instances of Application Module 1 are found in Cloud Providers A, B, and C; instances of Application Module 2 are found in Cloud Providers A and B; instances of Application Module 3 are found in Cloud Providers A and C; and an instance of Application Module 4 is found in Cloud Provider C.

In the illustrated embodiment, decentralizing the Application Modules across the Public Cloud can increase reliability of the system through redundancy, lower risk of failure through the use of multiple providers, lower system costs by paying for only those computing and data resources that are actually used, and remove barriers for rapid growth or retrenchment.

### Private Cloud

In the illustrated embodiment, the “Private Cloud” includes computing and data resources connected to the public Internet (but not accessible by the public) and one or more private networks. The Private Cloud contains two types of computing and data resources (i.e., an edge-cloud cache node or “Edge-Cache” and an end-cloud cache node or “End-Cache”).

In the illustrated embodiment, the Edge-Cache contains a copy of each Application Module in the Public Cloud, including its program logic and the data that corresponds (or is relevant) to the geographic location of the End-Cache(s) connected to it. The physical location of an Edge-Cache can be determined by the speed and reliability of the network used to communicate with its End-Cache(s) as well as its physical security. Although the Edge-Cache is usually connected to a local-area network of End-Cache(s), it can be connected to any network (e.g., wide-area network) or network topology (e.g., fiber, cable) of End-Cache(s) as long as speed, reliability, and security are not decidedly compromised. The Edge-Cache can help solve the practical limitations of cost versus speed for bandwidth to the public Internet. When speed requirements become less cost prohibitive, the Edge-Cache may no longer be needed and the End-Cache(s) will communicate directly with the Public Cloud. While cost remains a factor in some applications, the Edge-Cache can provide desired system functionality operability and at reduced costs.

In the illustrated embodiment, an End-Cache can contain computing and data resources to deliver content to a guest display (e.g., in-room TV) and receive input from its operator. It is typically positioned in close proximity to the display (e.g., inside the display as an integral part thereof, attached to the back of the display, attached to a piece of furniture on which the display rests) but preferably out of operator view. The End-Cache can receive operator input via input device(s) (e.g., remote control, keyboard, mouse), navigate system menus, perform or relay transactions (e.g., order movie, guest check-out), and render content, including: movies (e.g., hosted, provider-hosted, third-party hosted), television programming (e.g., over-the-air, cable, satellite), information (e.g., amenities, restaurants, shopping), and the like.

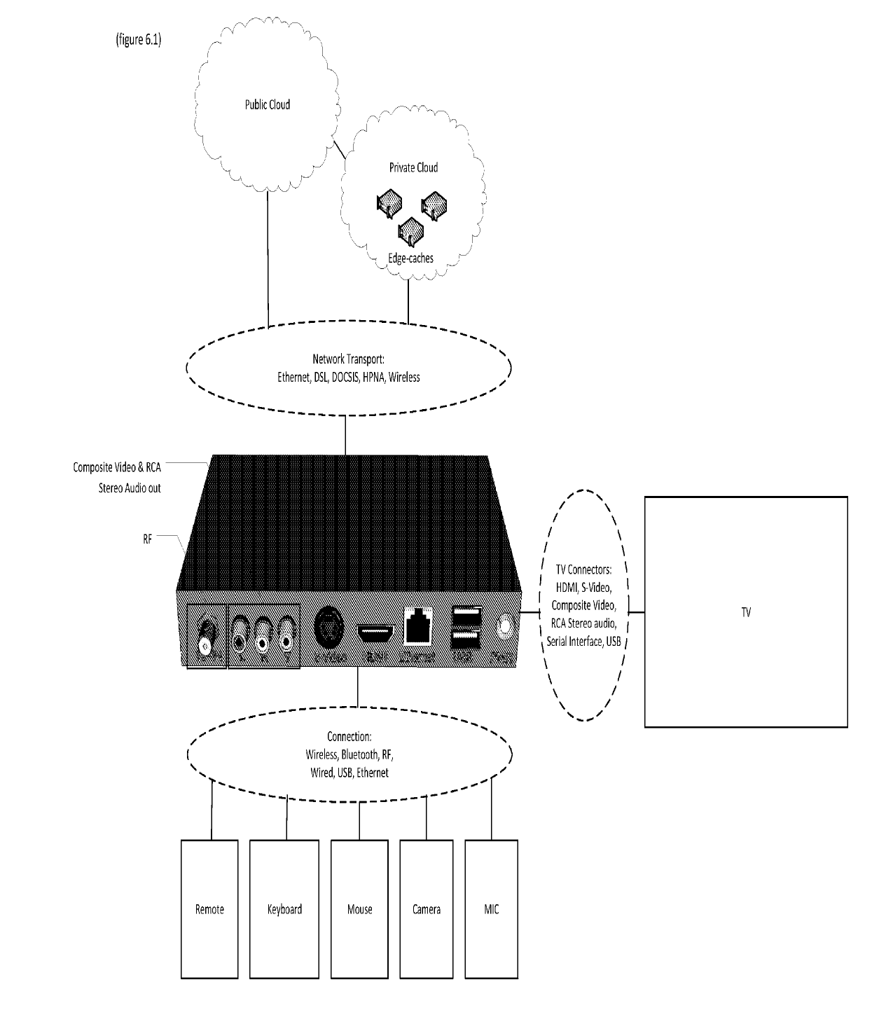

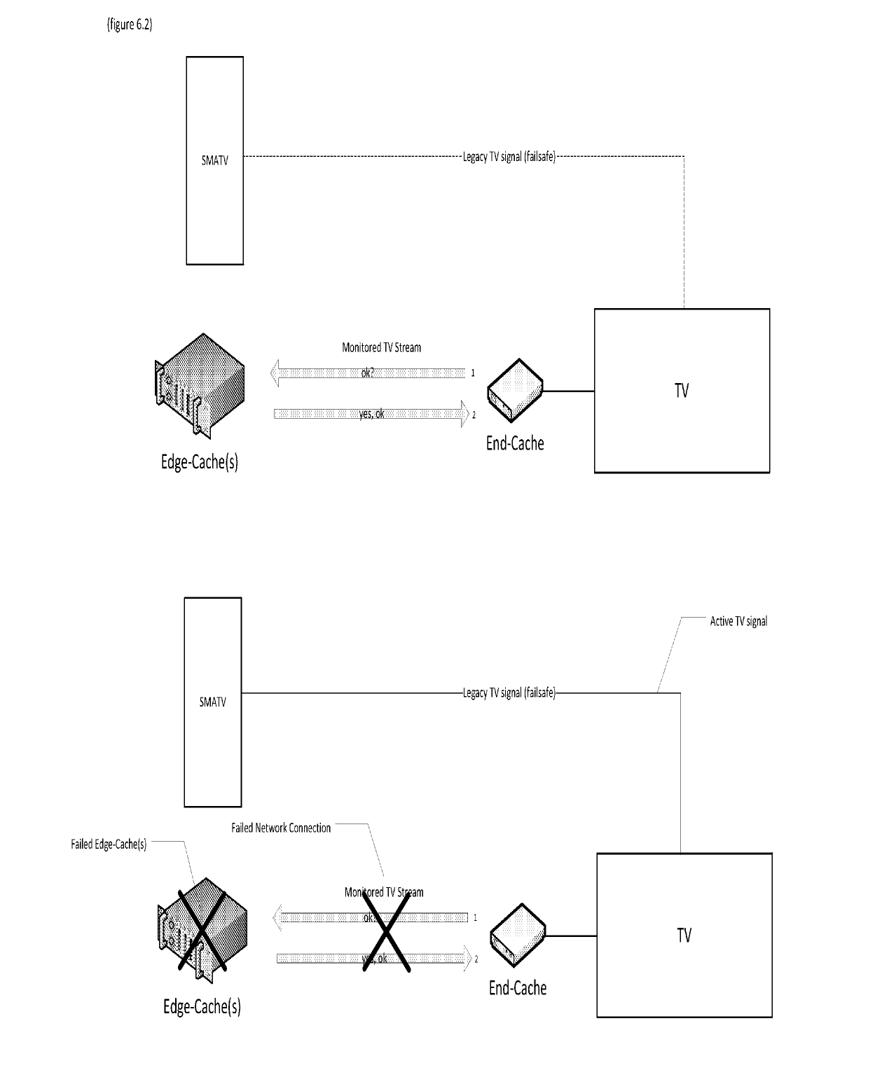

FIG. 4 is a schematic view that illustrates the manner in which the Private Cloud can be connected to the Public Cloud. In the illustrated embodiment, a private network connects three End-Caches (with no corresponding Edge-Cache) and two Edge-Caches to the Public Cloud (and to each other). The illustration also demonstrates three End-Caches connected to each Edge-Cache through a local network.

### Edge-Cache

In the illustrated embodiment, the Edge-Cache can comprise off-the-shelf hardware (e.g., industrial-quality components with preferably very small failure rates) and software, including a cache (or copy) of instances of Application Modules in the Public Cloud used by its corresponding End-Caches (i.e., those End-Caches with adequate connection speeds). The software is allocated, managed, and released through a “Private Cloud API” by the Resource Monitor. Each Edge-Cache relays data (e.g., transactions, status) between its End-Caches and Application Modules in the Public Cloud and caches content (e.g., movies, advertisements) for display by its End-Caches. The Resource Monitor uses additional viable Edge-Cache(s), if any, to balance the load of corresponding End-Caches. Thus, each Edge-Cache can connect to more than one End-Cache and each End-Cache can connect to more than one Edge-Cache.

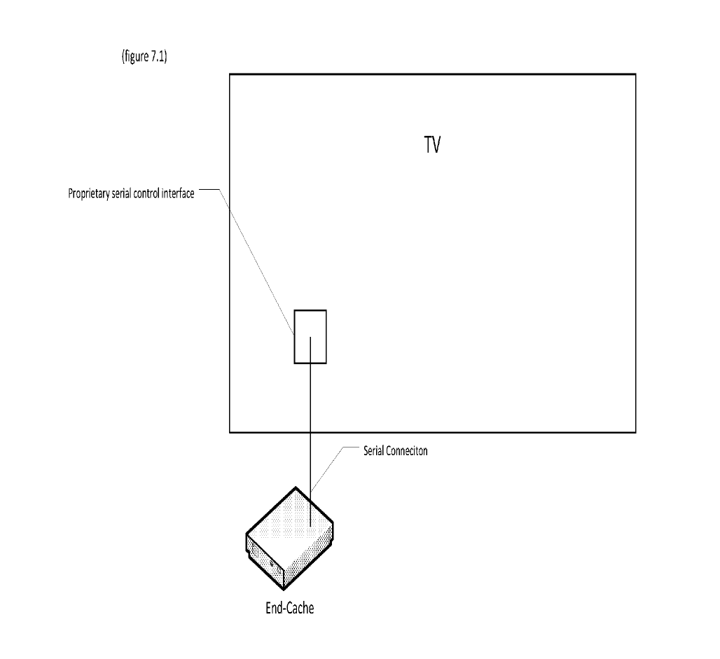

FIG. 5 is a schematic view that illustrates Application Module(s) in a Public Cloud cached through a private network to Edge-Caches in the Private Cloud as well as Edge-Cache failure recovery. In the illustrated embodiment, the third Edge-Cache fails and all End-Caches are redistributed and balanced among the two remaining Edge-Caches by the Resource Monitor.

As with Application Modules in the Public Cloud, the Resource Monitor designates the first instance of a particular Application Module as the “master” instance. Each instance thereafter requires separate hardware resources and is designated as a “slave” instance. Once again, there is no difference in the Application Module itself, only its designation—master or slave. According to one embodiment of the present invention, if the master instance of a given Application Module becomes unavailable (e.g., connection failure, hardware failure), the Resource Monitor can immediately designate the first slave instance as “master” or connect to the nearest viable Edge-Cache (or Public Cloud if none) and redistribute the load. If or when the original master instance is available again, the Resource Monitor can remove the “master” designation from the first slave (if any) and redistribute the load to include the original master instance.

### End-Cache

In the illustrated embodiment, the End-Cache can comprise proprietary hardware and software, including Application Modules.

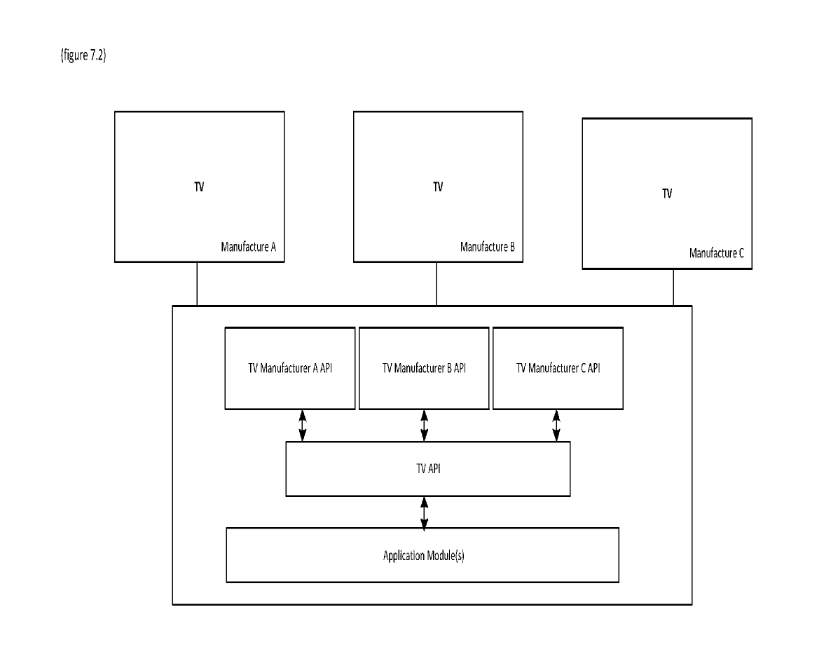

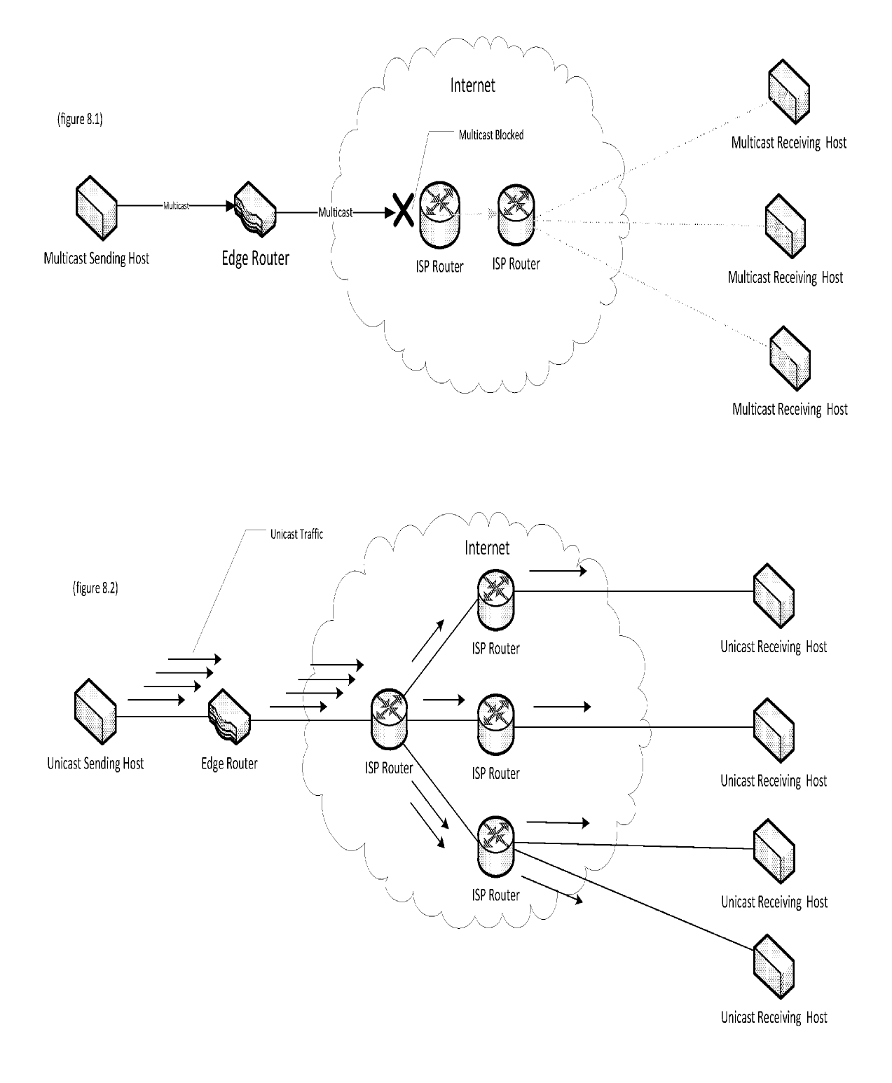

FIG. 6.1 is a schematic view that illustrates the manner in which the End-Cache interacts with Application Module(s) (whether at the Edge-Cache or the Public Cloud) as well as input and output devices. In the illustrated embodiment, hardware inputs can include local devices (i.e., one-to-one such as a remote, keyboard, mouse, etc.) via standard connections (e.g., infrared, RF, Bluetooth, wireless, cables) and network devices (i.e., several-to-several such as Edge-Caches, printers, etc.) via standard connections (e.g., Ethernet, DSL, wireless). Hardware outputs can include analog and digital video signals (e.g., RF, composite, sVideo, HDMI) for both standard-definition and high-definition content, TV control (e.g., input, channel, volume), and communication with Application Modules (whether at the End-Cache or Public Cloud).

Each End-Cache is connected to viable Edge-Cache(s) (or directly to the Public Cloud if none). It displays and allows the system operator to navigate through system menus and perform various functions (e.g., watch TV, order a movie, print a local restaurant choice, etc.). The TV channel lineup can originate from whatever source (e.g., cable providers like Comcast or Cox and satellite providers like DirecTV or Dish Network or future channel line-up providers via the Internet). Because of its importance, the End-Cache carefully monitors TV service accessibility.

FIG. 6.2 is a schematic view that illustrates the manner in which the End-Cache monitors the TV stream as well as failure recovery. In the illustrated embodiment, the End-Cache periodically pings the TV system resource. If it fails, the End-Cache automatically switches to the legacy signal (i.e., the TV signal used prior to installation), if any and system menus are updated to reflect the legacy channels (until the TV system resource is accessible again). The End-Cache can be notified that a particular TV channel is temporarily unavailable (e.g., hardware failure, service outage). In this case, the channel is removed from the channel lineup until the End-Cache is notified that the channel is available again.

The licensed content delivered to the End-Cache (e.g., movies, TV channels) can be secured using industry-standard encryption mechanisms (i.e., AES-256 bit—the same encryption required by the US Government for highly-sensitive data). Content (whether analog, digital, standard-definition, high-definition) delivered from the End-Cache to the guest display (e.g., in-room TV) is secured using industry-standard encryption mechanisms (i.e., Macrovision for composite and sVideo outputs and HDCP for HDMI output—no unencrypted signals like with component outputs are included).

### Display Control

Each hospitality-grade TV or “Hospitality TV” manufacturer supplies a communications port in the back of the unit and corresponding API to allow program control of the TV.

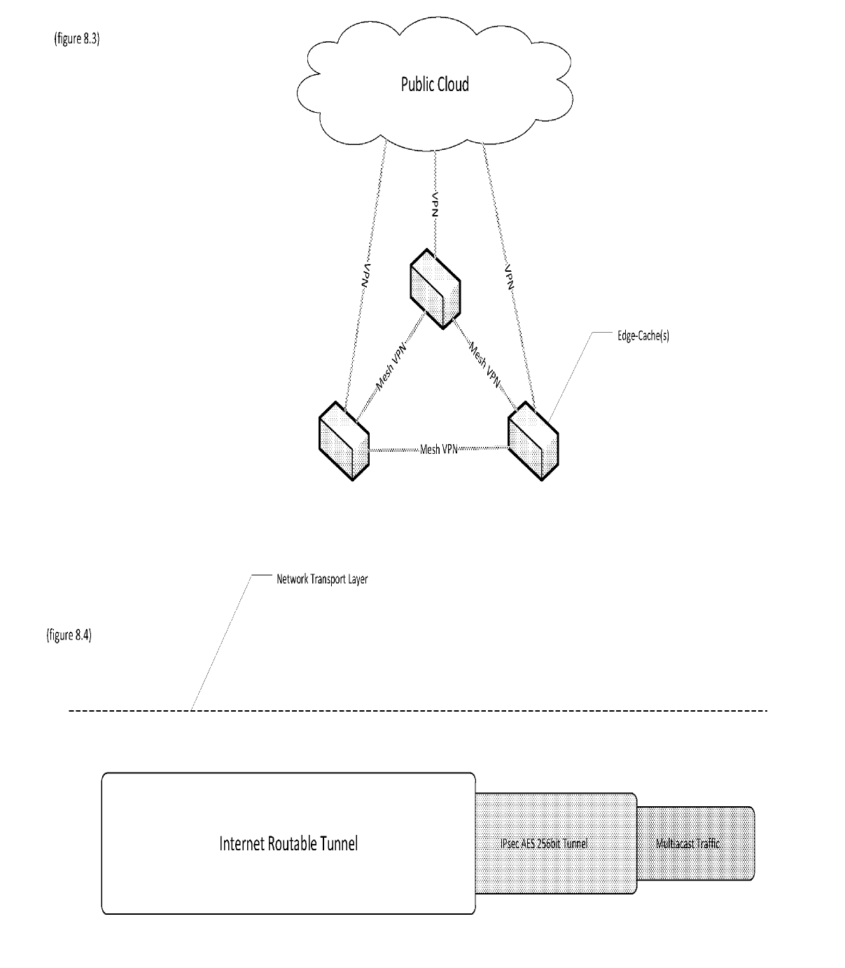

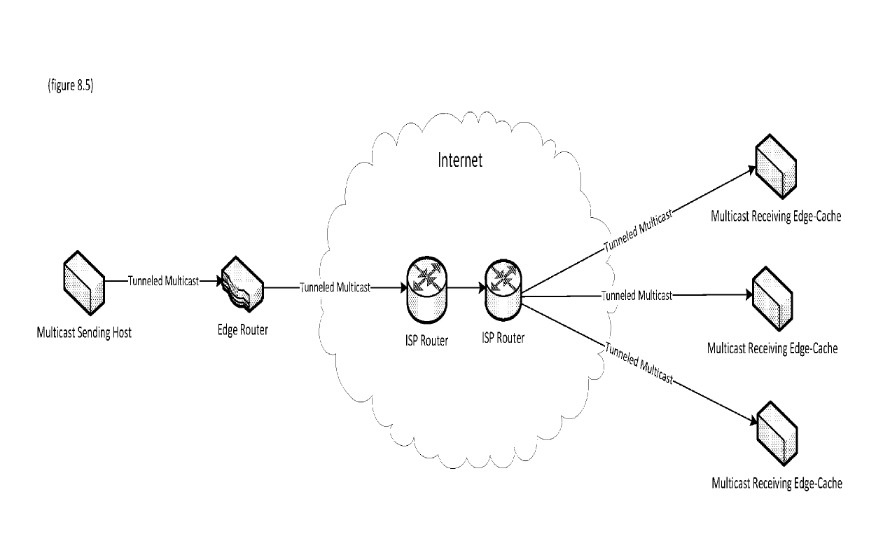

FIG. 7.1 is a schematic view that illustrates the manner in which a device is connected to the back of a Hospitality TV for program control. In the illustrated embodiment, the physical connection to an End-Cache is made through a proprietary serial control interface. Although each Hospitality TV API is specific to a given TV, Hospitality TV APIs themselves offer similar functionality and operate in a similar fashion.

FIG. 7.2 is a schematic view that illustrates the manner in which Hospitality TV APIs can be abstracted into a general purpose “TV API,” allowing applications to operate independent of a given Hospitality TV and its corresponding API.

In the illustrated embodiment, an application interacts with a single TV API to control operation of dissimilar TVs, including Manufacturer A, Manufacturer B, and Manufacturer C. This can be done by mapping the functional equivalent of each TV API call to its specific implementation using the given Hospitality TV API. In this way, supporting an additional Hospitality TV becomes the simple task of mapping the TV API to the new Hospitality TV API rather than the task of re-writing or reworking a large base of application program source code. The End-Cache uses the TV API to control, among other things, the TV input (e.g., new vs. legacy signal), channel (e.g., up, down, previous), volume (e.g., up, down, mute), and the like.

### Content Distribution

As previously stated, the Edge-Cache helps solve the practical limitations of cost versus speed for bandwidth to the public Internet. Thus, high-bandwidth files (e.g., movies and the like), are cached where they can be accessed with local-area network speeds (as opposed to slower and more-costly Internet connection speeds). These high-bandwidth files are uniquely and securely distributed from Application Module(s) in the Public Cloud to Edge-Caches in the Private Cloud.

Distributing digital media files (which can be quite large) to multiple locations has historically presented a problem (both in time and in cost). Some send copies on physical media (e.g., disc drives) to each location; while others use satellites to broadcast the data. In comparison, the public Internet represents a possible low-cost mechanism for distributing digital media files. However, the ability to “broadcast” a file (i.e., one-to-many) over the public Internet may not be allowed by Internet providers (i.e., ISPs, POPs, and backbone providers).

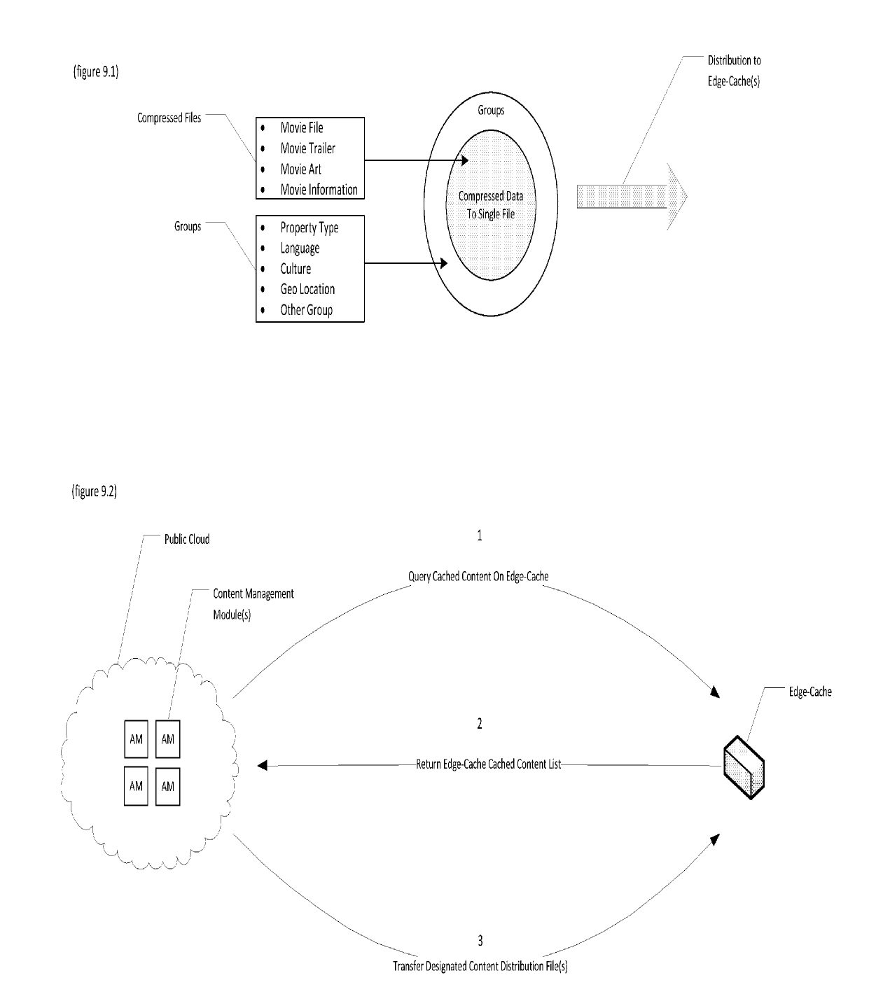

FIG. 8.1 is a schematic view that illustrates how attempts to broadcast file(s) using the public Internet are ignored (i.e., blocked or fire-walled) and the data is automatically discarded. In the illustrated embodiment, the multicast data is discarded by routers as it attempts to travel from the sending host to each receiving host. Nevertheless, one-to-one file transfers are permitted and can be a viable alternative as long as the file transfer time multiplied by the number of locations can be tolerated (both in time and in cost).

FIG. 8.2 is a schematic view that illustrates how one-to-one file transfers are properly routed over the public Internet. In the illustrated embodiment, the unicast data from the sending host is passed from router to router until it is received by the receiving host. Still, broadcasting digital media files over the public Internet may represent a more affordable and scalable solution. Secure communication (or data transfer) between Application Modules in the Public Cloud and Edge-Caches can be achieved through a virtual-private-network or “VPN.”

FIG. 8.3 is a schematic view that illustrates the manner in which Edge-Caches in the Private Cloud can be securely connected to the Public Cloud utilizing a “Mesh” VPN. In the illustrated embodiment, Application Modules can not only securely communicate with each Edge-Cache, but each Edge-Cache can also securely communicate with other Edge-Cache(s) when authorized to do so. File transfer is accomplished via tunnels (each a one-to-one connection between an Application Module in the Public Cloud and a desired Edge-Cache).

Since IP multicast (i.e., broadcast of one-to-many) is not permitted by Internet providers (i.e., the data would be discarded), the multicast traffic can be encapsulated with an Internet-routable tunnel and then encrypted using IP sec protocol and AES 256-bit (to encrypt the data packets); thereby circumventing multicast traffic normally discarded by Internet providers. In other words, since Internet providers can't see inside the encrypted tunnel, the broadcast traffic is allowed.

FIG. 8.4 is a schematic view that illustrates how multicast traffic can be encrypted and encapsulated so that it passes undisturbed through standard network transport layers of the public Internet.

FIG. 8.5 is a schematic view that illustrates the manner in which multicast traffic is broadcast. In the illustrated embodiment, tunneled multicast data from the sending host is passed from router to router until it is received by all receiving hosts (e.g., Edge-Caches). Thus, Application Modules in the Public Cloud can use the public Internet to securely broadcast large digital media file(s) simultaneously to all desired locations (e.g., Edge-Caches) using a Mesh VPN with Internet-routable tunnels with IP sec protocol and AES encrypted data of an IP multi cast stream.

Broadcasting digital media files over the public Internet represents a more affordable and scalable solution (i.e., required bandwidth is no larger than that needed for a connection to a single location and there is little or no change in bandwidth requirements as the number of locations increase).

### Content Management

A particular piece of content can be made up of many files. For example, a single movie may consist of the movie file, movie trailer file, movie art file, and movie information file. To reduce complexity and file size(s), all files that correspond to a given piece of content are grouped together and compressed (using industry-standard compression) into a single distribution file.

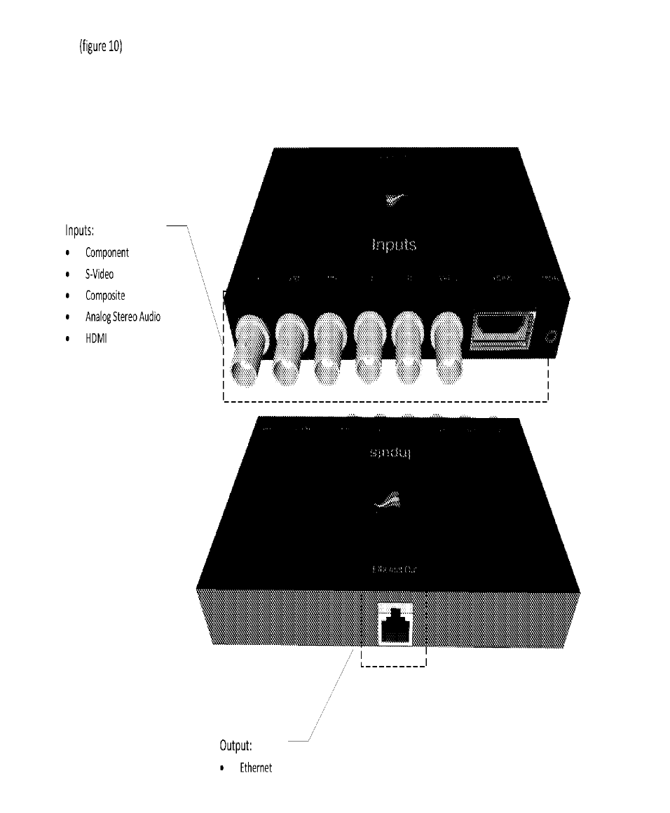

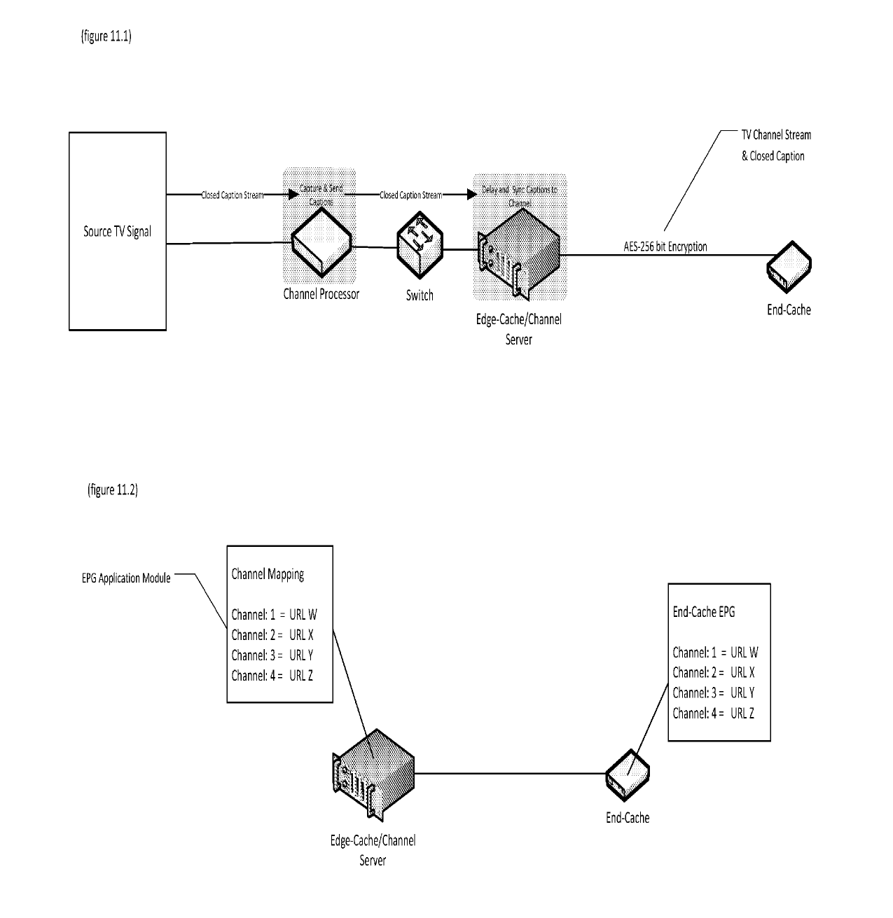

FIG. 9.1 is a schematic view that illustrates a content distribution file. In the illustrated embodiment, the compressed distribution file (which includes the movie, trailer, art, and information) is also associated with group attributes (e.g., property type, language, culture, geographic location). The “Content Manager” is an application that orchestrates the secure transfer of content distribution file(s) from the Public Cloud to corresponding Edge-Caches. Each Edge-Cache is queried to find out what content it currently has cached. This information is then compared to the content the Edge-Cache should have (based on factors, including its group attributes). The Content Manager then creates a distribution list for each piece of content and corresponding Edge-Caches that need that content.

Once the distribution list(s) are complete, the Content Manager transfers each distribution file by establishing a tunnel connection with all Edge-Caches that require the content file and then broadcasting the file as explained above. FIG. 9.2 is a schematic view that illustrates content distribution from Application Module(s) in the Public Cloud to corresponding EdgeCache(s). In the illustrated embodiment, a query is performed, a response is received, a distribution list is created, and a file is sent. This allows all distribution files to be broadcast and received by their corresponding Edge-Caches.

### Channel Processor

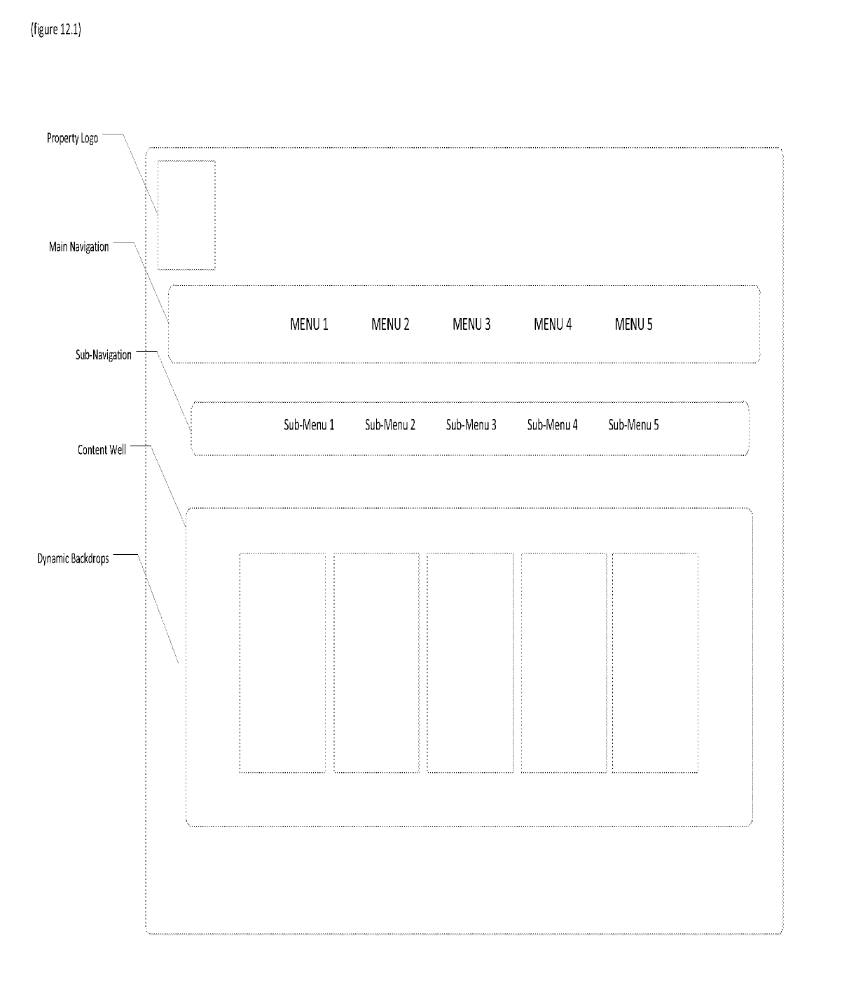

The Channel Processor or “CP” consists of proprietary hardware and software. FIG. 10 is a schematic view that illustrates the CP including its inputs and output. In the illustrated embodiment, the inputs are composite, sVideo, component, and HDMI and the output is Ethernet. Hardware inputs can receive either analog or digital video signals (e.g., std-def or high-def content) but only one signal can be processed at a time. According to one embodiment of the present invention, the CP performs the following functions in real-time:
if the video signal content is television, the closed-caption text is stripped off and output through the Ethernet port to the “Channel Server” Application Module at the Edge Cache for possible later use;
if the video signal is analog, the video signal is converted to digital, de-interlaced, and upscaled to high-def quality (minimum 720p);
the video signal is then processed, including: edge enhancement, mosquito noise reduction, color correction, and adjusted for sharpness, contrast, brightness, saturation, and gamma;
the aspect ratio of the video signal is modified (e.g., 4×3 with black bars in 16×9 frame, 4×3 stretch to 16×9 frame, 16×9 cropped to 4×3 frame, 16×9 with black bars in 4×3 frame), if desired (i.e., based on the CP's configuration);
the video signal is then encoded MPEG-4 (AVC/H.264); and
the video signal is output through the Ethernet port to the Channel Server at the Edge-Cache.

The CP is a network device and can be configured remotely. If no video signal is present, the CP sends a message to the Channel Server alerting the situation.

### Channel Delivery

Once at the Channel Server, the video signal is briefly delayed for closed caption syncing and then secured using AES-256 bit encryption before it is transmitted to the End-Cache(s). If closed captioning is desired, the closed caption text sent from the CP can be transmitted along with the encrypted video signal and displayed by the End-Cache(s).

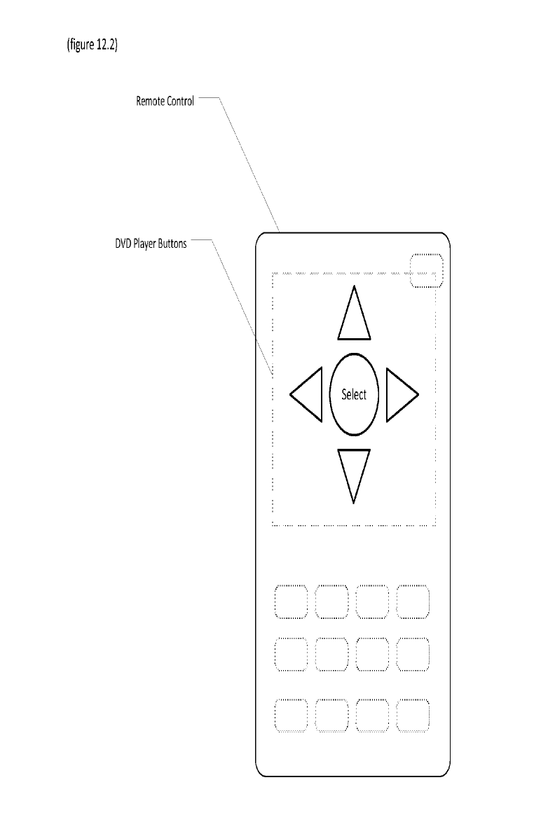

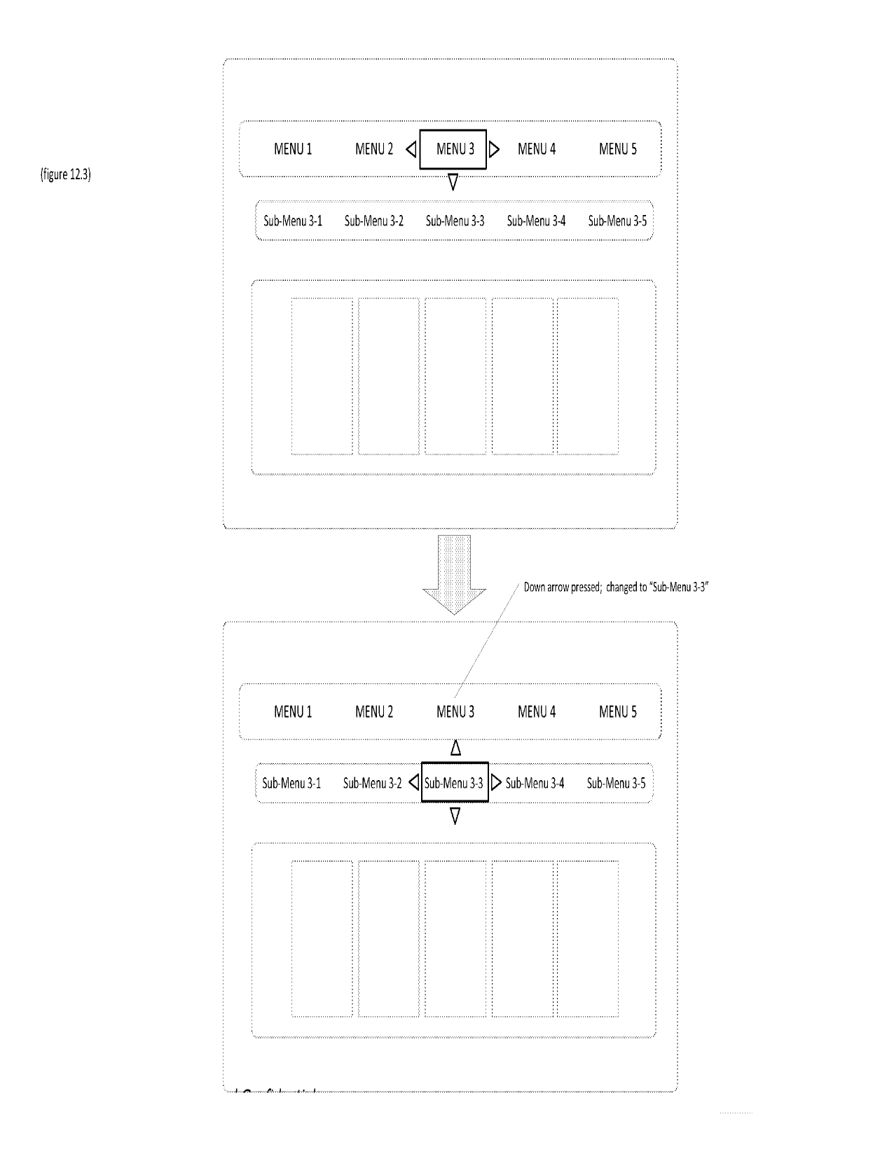

FIG. 11.1 is a schematic view that illustrates the manner in which a TV signal travels from its source to the End-Cache. In the illustrated embodiment, the source signal first travels to the Channel Processor, then to the Edge-Cache/Channel Server, and finally to the End-Cache.

In the illustrated embodiment, each real-time content signal (e.g., TV channel, welcome message) is broadcast from a specific URL at the Edge-Cache. Channel mappings are maintained by the EPG Application Module and viewing a specific channel is performed by simply connecting the End-Cache to the URL at the Edge-Cache that corresponds to that particular channel.

FIG. 11.2 is a schematic view that illustrates the manner in which channels are mapped. In the illustrated embodiment, the EPG Application Module maintains channel mappings that are communicated to the End-Cache EPG, including Channel 1 found at URL W, Channel 2 found at URL X, Channel 3 found at URL Y, and Channel 4 found at URL Z. The EPG also provides a mechanism for inserting VOD movies into the channel guide for immediate purchase and viewing. This method (also used by cable and satellite TV providers) may be familiar to many and provides a mechanism for cross-selling VOD movies.

According to one illustrative embodiment of the present invention, the system can provide local TV-DVR with pause, rewind, and fast-forward. Data is stored at the End-Cache to overcome potential licensing issues (e.g., content is viewed personal and not public). Pause time may be limited (e.g., sufficient for answering door, quick phone call, quick email, bathroom, etc. but not to pause through an entire set of commercials or while away at dinner). Also, Network TV-DVR with just missed TV can be provided allowing entire programs (e.g., latest episodes of hit TV shows, TV sporting events, special PPV-TV events) to be viewed for a fee (may require special licensing from channel line-up providers and corresponding content providers). Another feature allows current program information to be overlayed on the screen while a TV channel is being viewed. In this channel overlay mode, channel information can be cycled from channel-to-channel and a new channel can be selected at any time.

### User Interface

FIG. 12.1 is a schematic view that illustrates the main user interface elements displayed by the End-Cache. In the illustrated embodiment, the display is composed of a property logo, main-navigation menu, sub-navigation menu, and content well that appear to float on dynamic backdrops (i.e., images, video, or other digital content).

Consistency in user interaction can be helpful to new operators of the system (i.e., the operator intuitively knows what to do without thinking about it). System menus can be navigated using standard DVD player buttons (i.e., up, down, right, left, and select).

FIG. 12.2 is a schematic view that illustrates a DVD player remote control. In the illustrated embodiment, the standard DVD player buttons are highlighted. These buttons are also found on most audio/video remote control and their operation will tend to be familiar to most operators. When the up and down arrows are pressed, the highlight selection moves up and down the screen (centered horizontally) but doesn't move right or left (except inside the EPG grid; familiar to almost everyone).

FIG. 12.3 is a schematic view that illustrates vertical navigation. In the illustrated embodiment, when the down arrow is pressed, the highlight moves from the currently selected main menu item to the corresponding sub-menu item. Instead, when the right or left arrow is pressed, the menu options themselves scroll to the center (rotating like a big wheel) left or right respectively.

FIG. 12.4 is a schematic view that illustrates horizontal navigation. In the illustrated embodiment, when the right arrow is pressed, all menu items scroll left and the sub-menu that corresponds to the newly highlighted menu item is displayed below. As the highlight selection moves top to bottom, menu choices become more specific. For example, main menu options may be displayed horizontally at the top. Sub-menu options that correspond to the currently highlighted menu option may be displayed below. When select or down is pressed, the highlight moves to the sub-menu below and sub-sub menu options that correspond to the then currently highlighted sub-menu option are displayed below, and so on (until the bottom menu). The select button always performs just that (i.e., selects the highlighted option).

Menus options are dynamic (i.e., content driven) and display only if there is corresponding content. For example, if a particular channel is not broadcasting, the channel is removed from the channel guide until it returns. If there are no western genre movies, “western” will not appear as an available movie genre. If a special promotion expires, it no longer appears as an option. No changes are needed to the menu (or user interface) system.

According to one illustrative embodiment of the present invention auto-branding to the property can be accomplished through dynamic backdrops (e.g., menus float on images of the property). Also, closer content relationships with incremental revenue opportunities can be forged by auto-stitching current relevant movie trailer(s) at the start of a VOD movie and offering DVD or Blu-ray purchase at the end (fulfilled through third-party relationships such as iTunes, Amazon.com, and like).

### Digital Concierge

Local information (e.g., amenities, restaurants, shopping, attractions) can be monetized through paid inclusion in the “Concierge Application Module” which makes the information available on each guest display (i.e., in-room TV). Operators can select their desired choice(s) for printing (usually output to a network printer). The output provides information for the chosen selection which may include: establishment name, hours of operation, physical address, telephone number, travel directions, promotional coupons, and the like. Since guests represent highly targeted leads (i.e., a nearby captive audience), establishments (i.e., potential advertisers) may find it a worthwhile choice when deciding where to allocate their advertising budget.

### Computer Storage Media

The embodiments of the present invention may comprise a special purpose or general-purpose computer including various computer hardware, as discussed in greater detail below. Embodiments within the scope of the present invention also include computer-readable media, including computer-readable storage media, for carrying or having computer-executable instructions or data structures stored thereon. Such computer-readable media can be any available media that can be accessed by a general purpose or special purpose computer.

By way of example, and not limitation, such computer-readable media, or computer-readable storage media, can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computerized system that provides desired delivery of data to an end-user by utilizing a Public Cloud and one or more End-Caches and, optionally, one or more Edge-Caches, a computerized method comprising:
storing and delivering and optionally processing data in a decentralized system by grouping application functionality into application modules and associated data;
delivering one or more application modules and associated data by means of a Public Cloud;
caching one or more application modules and associated data to be available for local use such as in or by an Edge-Cache or End-Cache; and
utilizing one or more application modules and associated data to provide digital content, such as information and/or entertainment content, to a guest display.

2. The system of claim 1, wherein:
the system is decentralized in or through the Public Cloud providing one or more of increased reliability, lowered risk of system failure, lowered storage and delivery costs, and removed barriers for growth/retrenchment; and
wherein the system anticipates eventual resolution of the current speed/bandwidth versus cost barrier to the public Internet (e.g., for high-bandwidth content), thereby possibly removing the need for a local cache (e.g., Edge-Cache).

3. A computer program storage product comprising computer-executable instructions thereon that, when executed, cause one or more processors in one or more computerized systems to provide desired delivery of data to an end-user by utilizing a Public Cloud and one or more End-Caches and, optionally, one or more Edge-Caches, the computer program(s) or computer code or any other functionality comprising instructions for:
storing, and delivering and optionally processing data in a decentralized system by grouping application functionality into application modules and associated data;
delivering one or more application modules and associated data by means of a Public Cloud;
caching one or more application modules and associated data to be available for local use such as in or by an Edge-Cache or End-Cache; and
utilizing one or more application modules and associated data to provide digital content, such as information and/or entertainment services, to a guest display.

4. The computer program storage product of claim 3, wherein:
the computer program(s) or computer code or any other functionality are decentralized in or through the Public Cloud providing one or more of increased reliability, lowered risk of system failure, lowered storage and delivery costs, and removed barriers for growth/retrenchment; and
wherein the computer program(s) or computer code or any other functionality anticipate eventual resolution of the current speed/bandwidth versus cost barrier to the public Internet (e.g., for high-bandwidth content), thereby possibly removing the need for a local cache (e.g., Edge-Cache).

5. In a computerized environment that includes a public cloud and one or more end-caches and optionally one or more edge-caches, a computerized method of providing desired delivery of data to an end-user by utilizing, the method comprising:
using the public Internet to securely broadcast data, such as large digital media file(s), to desired locations (e.g., Edge-Caches) simultaneously;
allowing distribution of data and broadcast of such data economically (e.g., required bandwidth may be no larger than that needed for a connection to a single location); and
providing scalability such that a change in bandwidth requirements may not be required as the number of locations increases.

6. The method of claim 5, further comprising permitting content distribution which may be managed through distribution file attributes that can include property type, language, culture, geographic location, and defined group.

7. In a computerized environment that includes a public cloud and one or more end-caches and optionally one or more edge-caches, a method of utilizing a Channel Processor within a computerized system to improve a video signal received by an end-user comprising:
utilizing a video-input agnostic approach (e.g., composite, sVideo, component, HDMI);
utilizing a video signal agnostic approach (e.g., std-def, high-def);
converting and upscaling the video signal (e.g., analog to digital, std-def to high-def), and
improving the video signal through video processing if needed (e.g., edge enhancement, mosquito noise reduction, color correction, aspect ratio, and various adjustments for sharpness, contrast, brightness, saturation, and gamma).

8. The method of claim 7, further comprising:
overcomeing the poor quality of std-def analog signals viewed on high-def TVs (e.g., by outputting only digital high-def);
reducing previous delays in switching TV channels (e.g., between analog and digital TV tuners); and
improving even high-def signals (through video processing).

9. In a computerized environment having an architecture that includes a Public Cloud, one or more End-Caches, and optionally one or more Edge-Caches, a computerized method in which:
a content delivery application and functionality (i.e., Application module(s) and their corresponding data) live in a public cloud;
wherein the application and its functionality are cached where they are currently physically needed (i.e., Edge-Cache), and provide digital content, such as entertainment services and/or informational content, to a guest display (i.e., End-Cache connected to in-room TV).

10. In a computerized environment, a content distribution architecture configured to perform a computerized method in which:
a content delivery application and functionality (i.e., Application Module(s) and their corresponding data) live in the cloud (i.e., Public Cloud), and use the public Internet to securely broadcast large digital media file(s) simultaneously to all desired locations (e.g., Edge-Caches);
wherein Distribution files are broadcast in a very affordable and scalable way; and complex content distribution is more easily managed through distribution file attributes that can include: property type, language, culture, geographic location, and defined group.

11. In a computerized environment having an architecture that includes a Public Cloud, and one or more End-Cache, and optionally one or more Edge-Caches, a method of using a channel processor (CP) to improve video quality, in which:
the CP uses a video-input agnostic approach (i.e., composite, sVideo, component, HDMI) to take whatever video signal (i.e., std-def, high-def) is received and make it better (i.e., all digital, all high-def quality);
wherein the CP overcomes the very poor quality of std-def analog signals viewed on high-def TVs (i.e., outputs only digital high-def), makes moot previous delays in switching TV channels (e.g., between analog and digital TV tuners); and improves even high-def signals (through special video processing).
